(19) United States
(12) Patent Application Publication
(10) Pub. No.: US 2018/0090141 A1
(43) Pub. Date: Mar. 29, 2018

(54) CONVERSATIONAL INTERACTIONS USING SUPERBOTS

(71) Applicant: Microsoft Technology Licensing, LLC, Redmond, WA (US)

(72) Inventors: Panos Periorellis, Munich (DE); Marcel Tilly, Irschenburg (DE); Olivier Nano, Munich (DE); Francois Dumas, Munich (DE); Daniel Heinze, Munich (DE)

(73) Assignee: Microsoft Technology Licensing, LLC, Redmond, WA (US)

(21) Appl. No.: 15/280,984

(22) Filed: Sep. 29, 2016

(51) Int. Cl. G10L 15/22; G10L 15/18; G10L 13/08

(52) U.S. Cl. CPC G10L 15/22; G10L 2015/223; G10L 13/08; G10L 15/1815

(57) ABSTRACT

Conversational Super Bots are provided. A SuperBot may utilize a plurality of dialogs to enable conversation between the SuperBot and a user. The SuperBot may switch between topics, keep state information, disambiguate utterances, and learn about the user as the conversation progresses using each of the plurality of dialogs. Users/developers may expose a number of dialogs each specializing in a conversational subject as a part of the SuperBot. The embodiments provide enterprise systems that may handle multiple subjects in one conversation. SuperBot architecture allows dialogs to be added to the SuperBot and managed from the SuperBot. Dialog intelligence delivery via the SuperBot is decoupled from the authoring of the dialogs. Processes that make the SuperBot appear as intelligent and coherent to a user are decoupled from the dialog authoring. Developers may develop dialogs without considerations of language processing. The SuperBot includes components that manage and coordinate the dialogs.

### BACKGROUND

Conversational agents/bots that provide verbal interactions with users to achieve a goal, such as providing a service or ordering a product, are becoming popular. As the use of these conversational agents/bots increases in everyday life, there will be a need for computer systems that provide interaction between humans and conversational agents/bots that is natural, coherent and stateful. Also, there will be a need for computer systems that provide this interaction between humans and conversational agents/bots in an exploratory and/or goal oriented manner.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter

In example embodiments, methods and apparatus for implementing conversational SuperBots are provided. In the embodiments, a SuperBot may utilize a plurality of dialogs to enable natural conversation between the SuperBot and a user. The SuperBot may switch between topics, keep state information, disambiguate utterances, and learn about the user as the conversation progresses using each of the plurality of dialogs. The embodiments allow users/developers to expose several different dialogs each specializing in a particular service/conversational subject as apart of the SuperBot. This allows flexible service offerings. For example, the embodiments may be utilized to provide enterprise phone systems that may handle multiple subjects in one conversation. The SuperBot design and architecture is implemented so that individual dialogs may be added to the SuperBot and managed from the SuperBot. Dialog intelligence delivery via the SuperBot is decoupled from the authoring of the dialog themselves. The processes that make the SuperBot appear as intelligent and coherent to a user are decoupled from the dialog authoring. This allows developers to develop their dialogs without considerations of natural language processing. A SuperBot configured according to the embodiments includes selected conversational components that manage and coordinate the plurality of dialogs. The selected conversational components are implemented to allow generic functions to be handled by the SuperBot across different dialogs and maximize efficiency in conducting a conversation with a user. These selected conversational components provide enhanced interaction between a user and the SuperBot as compared to using a plurality of dialog bots individually. The SuperBot handles all context information within one conversation and enables the user to switch between dialogs.

In an example implementation, a SuperBot may be implemented as an apparatus that includes one or more processors and memory in communication with the one or more processors. The memory may include code that, when executed, causes the one or more processors to control the apparatus to provide the functions of a flow engine within the SuperBot to manage a conversation. In response to receiving input, the apparatus may activate the SuperBot for managing a conversation, where the SuperBot is operable to manage a plurality of dialogs including at least a first and second dialog, receive a first utterance and invoke the first dialog in response to receiving the first utterance, receive and/or determine first contextual information and/or state information for the conversation using the first dialog, receive a second utterance and switch from the first dialog to the second dialog for the session in response to receiving the second utterance, and utilize the first contextual information and/or state information to determine at least one response using the second dialog. The apparatus may further receive second contextual information and/or state information for the conversation while using the second dialog, receive a third utterance and switch back to the first dialog in response to receiving the third utterance, and utilize the second contextual and/or state information to determine at least one response while conducting the first dialog. The apparatus may receive the second utterance while in the first dialog and rank the relevance of the second utterance to possible dialogs by ranking the second utterance for relevance to the second dialog and to at least one other dialog. After determining that the second utterance is most relevant to the second dialog as compared to the at least one other dialog, the apparatus may switch to the second dialog.

In the example implementation, the apparatus may track contextual information and/or state information for the conversation throughout the conversation while using all the invoked dialogs. The apparatus may then utilize the tracked contextual information and/or state information to determine responses across all dialogs used in the conversation. For example, contextual information and/or state information tracked in the conversation while using the first or second dialog may be utilized to determine responses across dialogs, such as while the conversation is using a third dialog. Also, the apparatus may determine dialog activity that includes an amount of activity of each of the first and second dialogs in the ongoing conversation, receive an utterance, and determine, based on the dialog activity, whether the first or second dialog is to be invoked in response to the utterance. For example, if an ambiguous utterance is received the most active dialog in the conversation may be invoked.

### BRIEF DESCRIPTION OF THE DRAWINGS

FIG. 1 is a simplified diagram illustrating an example SuperBot conversation using an example device and network apparatus;

FIG. 2 is a simplified block diagram illustrating an example flow engine (that controls that follow of a conversation) of a SuperBot;

FIG. 3 is a flow diagram illustrating example operations performed in a conversation according to an implementation;

FIG. 4A is an example dialog structure for a dialog used in a SuperBot;

FIG. 4B is an example data slot structure for a dialog used in a SuperBot;

FIG. 4C is an example exit structure for a dialog used in a SuperBot;

FIG. 4D is an example trigger structure for a dialog used in a SuperBot;

FIGS. 5A-5C arc diagrams illustrating an example construction of a dialog for use in a SuperBot; and,

FIG. 6 is a simplified block diagram illustrating an example apparatus for implementing conversational SuperBots.

### DETAILED DESCRIPTION

The system and method will now be described by use of example embodiments. The example embodiments are presented in this disclosure for illustrative purposes, and not intended to be restrictive or limiting on the scope of the disclosure or the claims presented herein.

The embodiments of the disclosure provide a SuperBot that enables natural conversation between the SuperBot and users by utilizing the SuperBot's capacity for conducting and managing multiple types of dialogs. The SuperBot is configured to switch between topics that may be each associated with separate dialogs, track the state of the conversation through the multiple dialogs, and, track and learn contextual information associated with the user through the multiple dialogs as the conversation progresses. The SuperBot allows natural interaction in conversations between users and the SuperBot using multiple dialogs. The use of the SuperBot results in convocations that are natural and stateful and may be either exploratory or goal oriented. The embodiments also include a design/architecture that allows individual dialog bots to be added to the SuperBot and managed by the SuperBot during conversations.

Advantages are provided by the SuperBots of the embodiments in that the SuperBots may handle a number of conversation topics in a manner that feels more natural to a user. For example, enterprises/business entities can expose a number of dialogs, each specializing in a particular service by using a single SuperBot. This provides an advantage over currently used conversational agents and systems that offer verbal interactions to users in a stateless request/response type of interaction. In the stateless request/response type of interaction, a system basically asks a question of a user to which a response is provided. Although there are many stateless request/response dialog bots that deal with specific topics and can deliver either single turn or limited multi-turn dialogs, these stateless request/response dialog bots have shortcomings in that they struggle to deal with multiple conversational topics. The SuperBot of the embodiments overcomes these shortcomings.

In an example scenario, an enterprise may use the technology and techniques of the embodiments to author dialogs associated various services they offer, make those dialogs available to a SuperBot, and implement the SuperBot to respond to customer requests. For example, Company A may be offering a set of services to its customers, such as internet connectivity, mobile connections or smart TV channels. Customers can visit Company A's website and sign up for contracts. Company A may make these offerings also available via a SuperBot in Skype or other messaging platforms or simply want customers to have a conversation with a virtual agent to obtain a contract for internet or mobile. Company A would like to be efficient in terms of bundling its different offerings, so a customer can sign up for internet connectivity together with a new mobile contract or sign up for smart TV while upgrading to a new mobile phone contract. Company A may author dialogs for such virtual agents according to the embodiments. For example, one of the dialogs may be authored as a first dialog which can handle the new internet flat rate offering, a second dialog may be authored to handle service calls, and a third dialog may be authored to handle the subscription for new smart TV channels. Thus, Company A may use the authored dialogs bundled for use as a SuperBot during runtime.

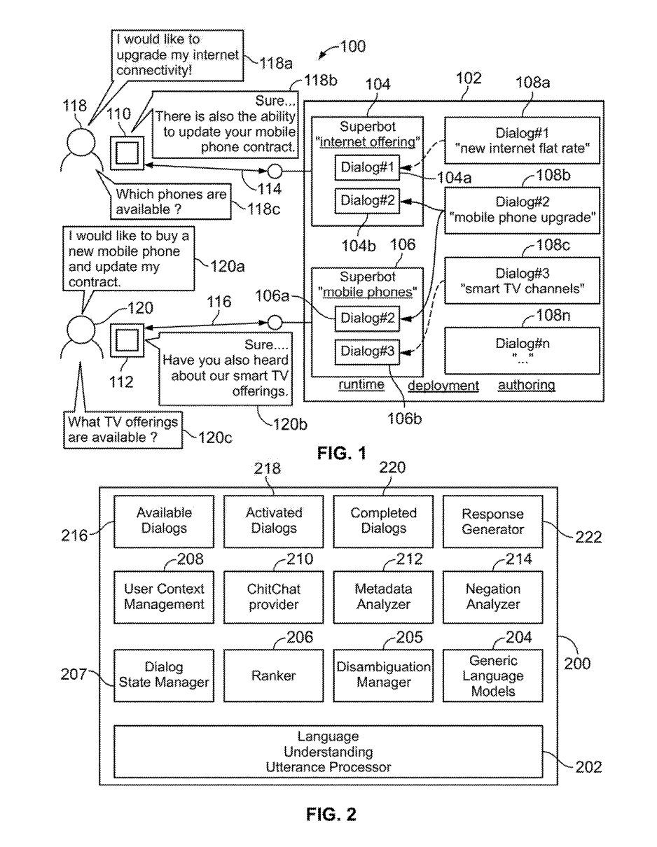

FIG. 1 is a simplified diagram illustrating example SuperBot conversations using example user devices and a network apparatus. In the example of FIG. 1, network apparatus 102 may comprise one or more servers, or other computing devices, that include hardware/processors and memory including programs configured to implement the functions of the SuperBot. Apparatus 102 maybe configured to provide SuperBot conversational functions for an Enterprise, or for any other use applications that may utilize the enhanced voice and conversational processing provided by the SuperBot functions. Devices 110 and 112 may be mobile devices or landline telephones, or any other type of devices, configured to receive audio input, respectively, from users 118 and 120, and provide conversational audio input to apparatus 102 over channels 114 and 116. Channels 114 and 116 may be wireless channels, such as cellular or Wi-Fi channels, or other types of data channels that connect devices 110 and 112 to apparatus 102 through network infrastructure. In other example implementations, devices 110, device 112 and apparatus 102 may also be configured to allow users 118 and 120 to provide conversational input to the SuperBot using other types of inputs such as keyboard/text input.

In FIG. 1, apparatus 102 is shown as conducting two example conversations involving customer interaction tor a communications Enterprise. User 118 of device 110 is in a conversation managed by SuperBot 104 and user 120 of device 112 is in a conversation managed by SuperBot 106. SuperBots 104 and 106 may represent SuperBots that are separately implemented in different hardware and/or programs of apparatus 102, or may represent the same SuperBot as it manages separate conversations. Apparatus 102 also includes stored authored dialogs dialog-1 to dialog-n that are configured to handle dialog on selected topics. Different dialogs of dialog-1 to dialog-n each may be utilized by SuperBots 104 and 106 depending on configuration of the SuperBots 104 and 106. In configuring SuperBots 104 and 106, a network manager may bundle particular dialogs of dialog-1 to dialog-n into the SuperBot, depending on the topics that may come up in the course of a conversation with a user. In FIG. 1, dialog-1 and dialog-2 are shown bundled into SuperBot 104 and dialog-2 and dialog-3 are shown bundled into SuperBot 106. In other implementations, any number of dialogs may be bundled in one SuperBot. The dialog that is used by SuperBot 104 or 106 at a particular time depends on the contexts/states of the conversation as tracked by SuperBot 104 or 106.

In FIG. 1, user 118 has provided conversational input 118a to SuperBot 104, as “I would like to upgrade my internet connectivity”. At that point in the conversation SuperBot 104 invokes dialog-1 that is configured as a dialog related to the tonic of “new internet flat rate”. SuperBot 104 may invoke dialog-1 based on certain utterances that are included in the conversational input 118a and that are defined as triggers for dialog-1. For example, the utterances “upgrade” and/or “internet connectivity” may be defined for SuperBot 104 to trigger dialog-1. The invoking of dialog-1 may also include determining a relative rank of dialog-1 relative to other dialogs, dialog-2 through dialog-n, as a likely dialog for invocation based on the triggers. SuperBot 104 may then manage a conversation with user 118 about user 118's internet connectivity/service. At some point in the conversation, SuperBot 104 may invoke dialog-2 “mobile phone upgrade” and query user 118 about the user's mobile phone using conversational output 118b as: “There is also the ability to update your mobile phone contract.” In one scenario, SuperBot 104 may provide conversational output 118b in response to a trigger utterance received from user 118. For example, may be based upon the trigger utterance “upgrade” received during dialog-1 and state information tracked during dialog-1 that indicated dialog-1 has been completed. Context information on user 118 may also be used by SuperBot in determining to provide conversational output 108b. For example, information received from user 118 during dialog-1 regarding the fact that user 118 has a mobile phone contract may be utilized. In other examples, user 118 may ask directly about mobile phone upgrades and trigger dialog-2 in the middle of dialog-1. In response to conversational output 108b, user 118 may provide conversational input 118c as “Which phones are available”? SuperBot 104 may then conduct a conversation with user 118 using dialog-2. Depending on the trigger utterances included in the conversational input from user 118, SuperBot 104 may switch back and forth between dialog-1 and dialog-2, or invoke another dialog of dialog-1 to dialog-n that is bundled with SuperBot 104.

In the conversation with SuperBot 106, user 120 has provided conversational input 120a as “I would like to buy a new mobile phone and update my contract.” At that point in the conversation SuperBot 106 invokes dialog-2 that is configured as a dialog related to the topic of “mobile phone upgrade”. SuperBot 106 may invoke dialog-2 based on certain utterances that are included in the conversational input 120a and that are defined as triggers for dialog-2. For example, the utterances “update”, “buy” and/or “mobile phone” may be defined for SuperBot 106 to trigger dialog-2. The invoking of dialog-2 may also include determining a relative rank of dialog-2 relative to other dialogs, such as dialog-3 and any other dialogs up through dialog-n that are bundled in SuperBot 106, as a likely dialog for invocation based on the received triggers. SuperBot 106 may then manage a conversation with user 120 about user 120's mobile phone service. At some point in the conversation, SuperBot 106 may invoke dialog-3 “smart TV channels” and query user 120 about the user's smart TV service using conversational output 120b as: “Have you also heard about our smart TV offerings?” In one scenario, SuperBot 106 may provide conversational output 120b in response to a trigger utterance received from user 120. For example, output 120b may be provided based upon the trigger utterance “smart TV” having been received during dialog-2, and on state information tracked during dialog-2 that indicates dialog-2 has been completed. Context information on user 120 may also be used by SuperBot 106 in determining to provide conversational output 120b. For example, information received from user 120 during dialog-2 regarding the feet that user 120 does not have a TV contract may be utilized. In other examples, user 120 may ask directly about smart TV services and trigger dialog-3 in the middle of dialog-2. In response to conversational output 120b, user 120 may provide conversational input 120c as “What TV offerings are available?” SuperBot 104 may then conduct a conversation with user 120 using dialog-3. Depending on the trigger utterances included in the conversational input from user 120, SuperBot 106 may switch back and forth between dialog-2 and dialog-3, or invoke another dialog of dialog-1 to dialog-n that is bundled in SuperBot 106.

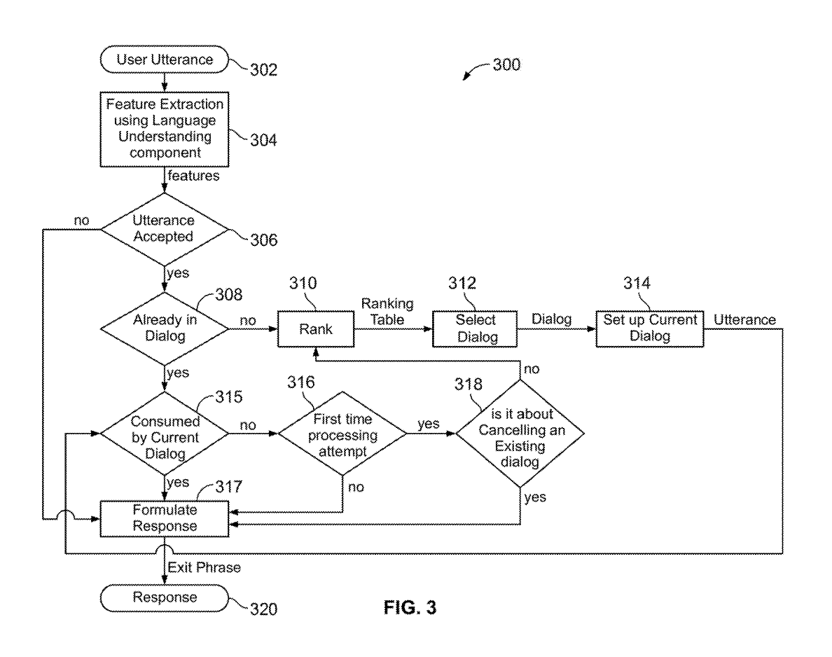

FIG. 2 is a simplified block diagram illustrating an example SuperBot flow engine. In an example implementation, flow engine 200 may be implemented in Super Bots 104 and 106 of apparatus 102 in FIG. 1. Flow engine 200 may be implemented in apparatus 102 using hardware and processors programmed to provide the functions shown in FIG. 2. The design of flow engine 200 enables the decoupling the technology components that cause a dialog to be delivered in an intelligent manner from the design of the individual dialogs. Use of flow engine 200 allows developers to create dialogs for a particular service offering without considering natural language processing, artificial intelligence or the need to script all possible utterances a user of that dialog could utter. Use of flow engine 200 allows the individual dialogs that are bundled within a SuperBot to be delivered in a coherent manner. Flow engine 200 is configured to allow this through the implementation of a number of components within the flow engine that may be considered generic, i.e. most dialogs will require them. The components of flow engine 200 allow the SuperBot to handle dialog mechanics or conversation flows that are common to the dialogs of the SuperBot with which they are bundled. The components of flow engine 200 also are configured to be able to understand a larger number of utterances than the individual dialogs themselves. An example, an utterance common to many dialogs by which the user is asking for available response options to a particular question output by the dialog maybe handled by the flow engine.

Flow engine 200 includes language understanding/utterance processor 202. Language undemanding/utterance processor 202 provides language tools that allow flow engine 200 to determine the structure of an utterance. This determination of structure includes spelling and grammar evaluation, part of speech (POS) tagging, stemming, dependency trees, etc. Language understanding/utterance processor 202 performs the initial analysis of a sentence for flow engine 200. Language filters for rudeness, swearing etc. may also be implemented in language understanding/utterance processor 202. Language understanding/utterance processor 202 provides the first initial feel of the validity of the utterance in flow engine 200. Generic language models (GLMs) 204 functions are used to handle utterances are used often in different conversations. This may include, for example, asking the SuperBot to cancel or stop discussing a particular topic such as food ordering. For example, in the middle of ordering pizza the user may change his mind and asks the dialog system to cancel the order. These utterances handled by GLMs 204 may also include requests about the possible optional responses to a question. For example, when asked about pizza toppings a user may ask what the choices are available. Utterances handled by GLMs 204 may also include asking about the state of a returning conversation, asking what was understood by the system (state check), asking to recap the main points of a dialog flow, or asking about dialog specifics like “what is Uber”. Instead of having dialog designers predicting all these possible utterances for a particular dialog, the flow engine takes care of those utterances that GLMS 204 may understand. In this case then, for example, a pizza service dialog designer does not have to script a response to covering the possible utterance of a user asking for toppings option s or the state of an order. GLMs 204 of flow engine 200 will handle those utterances. Disambiguation manager 205 functions as a resolver for GLMs 204. Since GLMs 204 handle multiple dialogs they cannot be scripted. For example, responding to a user asking for pizza toppings options is different from a user asking for car rental options. In situations such as this, disambiguation manager 205 is able to extract data from the dialog scripts and synthesize a natural language response. When a user is asking for state of the dialog, or options to for the system to recap, resolvers synthesize the response.

Ranker 206 of flow engine 200 will look at each of the individual dialogs that flow engine 200 is bundled with and identify how closely the utterances of the user match the contexts of particular dialogs. This allows generation of a ranking table that is sorted based on the relevance of each of the available dialog scripts to a particular user utterance. Flow engine 200 may then push the utterance to the most relevant dialog and the most relevant dialog will take over the conversation. If the dialog determined to be most relevant rejects the utterance, flow engine 200 will move to the second most relevant dialog in the ranking table and continue the process until a dialog accepts the utterance. If ranker 206 does not find any relevant dialogs, flow engine 200 will cause the SuperBot to respond to the user that the utterance was not understood.

Dialog state manager 207 is a component that tracks and manages the state of dialogs involved in a conversation. Dialog state manager allows flow engine 200 to move smoothly back and forth between different dialogs by tracking the states of the dialogs as a user moves between the dialogs.

User context management function 208 of flow engine 200 is a component that accumulates knowledge about the user and uses that knowledge as a conversation flows through multiple dialogs. When a user converses with the SuperBot the user may or may not have a history with that system. For example, a first dialog designer may script a first dialog to assist users when installing a selected program on a PC and a second dialog designer may script a second dialog to activate that selected program on a PC. The first and second dialogs refer to different tasks that can be performed completely independent from each other or within a short time interval of each other. For both, first and second dialogs, a request to the user to respond with device type information, for example PC or MAC, and license identification information will most likely be made. If a user interacts with the first dialog while asking for help regarding Installation of the selected program, the SuperBot will ask for license identification information and device type information. Similarly, when activating the selected program using the second dialog some of the same information would be required. User context management 208 allows information to be tracked and saved as accumulated information that may be reused without requiring the user to repeat the information. Flow engine 200 will pick up the question from the second dialog script when the user begins the second dialog to activate the selected program and will process the question with the state information it tracked and save as accumulated information during the first dialog used to install the selected program. The second dialog script has no information on where the utterance came from, but the conversation with the user is more natural.

Chitchat provider 210 is a component that provides flow engine 200 and the SuperBot that executes flow engine 200 with a set of chitchat capability. The purpose of the chitchat provider 210 is to provide the coordination between dialog topics. Metadata analyzer 212 allows a user to query a dialog and obtain information about the dialog. The designer of a dialog may introduce metadata into their dialog script that metadata analyzer 212 will use to synthesize a sentence about the dialog and other dialog related data, such as number of data slots, to describe the dialog to a user. Negation Analyzer 214 will understand if a sentence contains negation and it will negotiate a response with the dialog script or ask the user to response positively. This also adds intelligence to the conversation without a dialog designer to have to specify this in the dialog script. Negation analyzer 214 prevents a problem encountered in dialog systems where the dialog designer assumes only a positive path towards the completion of a task or goal, with no provision for negative utterances. For example, in a pizza ordering dialog a user may provide an utterance about which pizza toppings he does not like or wish. If there is no provision for negative utterances, a dialog could go wrong, as a negative response may be convened to positive and the utterance ‘I don't like pineapple’ may result in pineapple on the pizza order. Negation analyzer 214 prevents this from happening.

Flow engine 200 also includes the components of available dialogs 216, activated dialogs 218, and completed dialogs 220. Flow engine 200 keeps track of the most active dialogs and the dialog that is currently engaging with the user through activated dialogs 218, completed dialogs through completed dialogs 220, and available dialogs through available dialogs 216. Flow engine 200 can make determinations as to actions when certain utterances are received. For example, when a user asks for a recap of the current dialog conversation flow engine 200 may determine the most active dialog using activated dialogs 218 and assume that the user is referring to that. When a user utters something for a dialog that has been completed and is not repeatable, or has some time limit before being repeated, How engine can respond accordingly using completed dialogs 220.

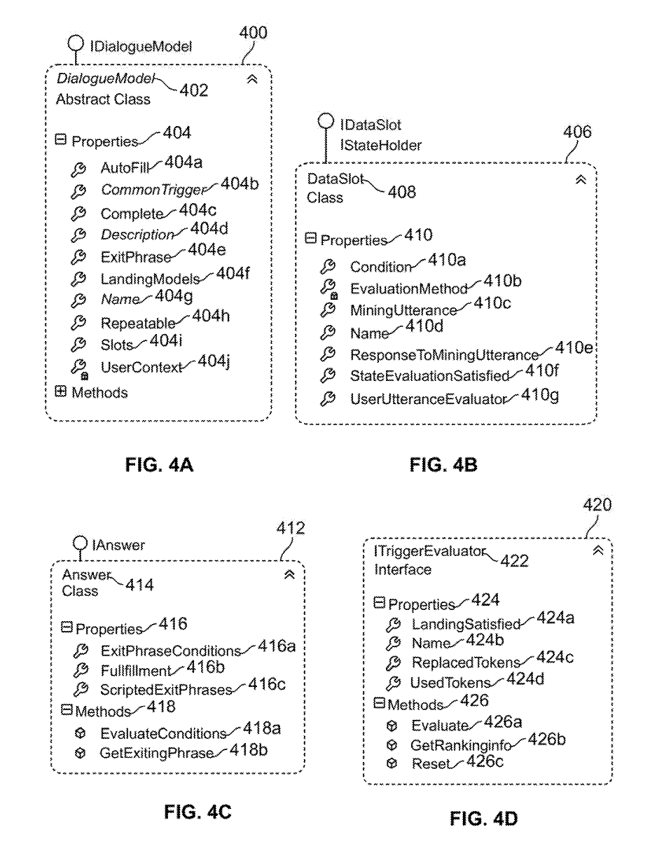

FIG. 3 is a flow diagram illustrating example operations performed in a conversation according to an implementation of the SuperBot. FIG. 3 shows how utterances received from a user in a conversation may be processed by flow engine 200 to generate a response to the user. The process begins at 302 where the SuperBot receives a conversational input comprising an utterance from a user. At 304, flow engine 200 performs feature extraction on the utterance using language understanding utterance processor 202. At 305, it is determined if the utterance is accepted. If the utterance is not accepted the process moves to 317 and a response is formulated by response generator 222. For example, when the utterance is not accepted the response may be a request to the user clarification or a request that the user repeat the utterance. At 320 the response is provided to the user. If however, at 306, it is determined that the utterance is accepted, the process moves to 308.

At 308, flow engine 200 determines whether the SuperBot is already in an current dialog with the user by using dialog state manager 207 and/or activated dialogs 218. If it is determined that the SuperBot is already in the current dialog, the process moves to 315. However, if it is determined that the SuperBot is not already in the current dialog the process moves to 310. At 310, ranker 206 ranks the utterance using a ranking table to determine a ranked order of most relevant available dialogs for the utterance from available dialogs component 216. Next, at 312, the most relevant of the ranked available dialogs is selected, and at 314, the selected dialog is set up as the current dialog. Next the process moves to 315.

At 315, which may be entered from 308 or 314, flow engine 200 determines if the utterance is consumed by the current dialog, i.e., determines if the utterance is relevant to, and can be processed for, the current dialog. In an example implementation, flow engine 200 may use user context management component 208, the features extracted earlier in the flow by language understanding utterance processor 202, and disambiguation manager component 205 to determine if the utterance is consumed by the current dialog. If the utterance is consumed by the current dialog the process moves to 317 where a response to the user according to the current dialog is formulated. Then, at 320, the response is provided to the user. If however, at 315, it is determined that the utterance is not consumed by the current dialog the process moves to 316. At 316 it is determined if it is the first time this utterance has been processed or if an attempt to process the utterance was previously performed. If the utterance was previously processed the process moves to 317 where flow engine 200 formulates a response. The response may be a request for clarification from the user. If however, it is determined at 316 that it is the first time the utterance is being processed, the process moves to 318. At 318 it is determined if the utterance is about canceling the conversation or about an existing dialog. If the utterance is not about canceling the conversation or about an existing dialog the process moves to 310. At 310 flow engine then uses ranker 206 to perform the ranking process to select a dialog from available dialogs at 312 and setup the selected dialog as current dialog. If the utterance is about canceling the conversation or an existing dialog the process moves to 317 where a response is formulated. The operations of FIG. 3 are performed for each utterance received until a response for the utterance is generated. Flow engine 200 may provide a complete conversation with a user by processing the user's utterances according to FIG. 3 and switching between dialogs as needed.

In the implementation of FIG. 3, operations 302 through 320 illustrate an example of a decision path that may be followed in formulating a response to an utterance by using information from the components of flow engine 200. In other implementations, information from any of the components of flow engine 200 may be used to formulate responses using other decision paths that are structured differently.

FIG. 3 may be explained using an example conversation that illustrates how the basic context of a conversation, such as data slots, user context, and status is used. The example shows handling of chit chat, generated dialog (for example, when user asks about options it is the flow engine that responds), and talking out of turn (the user is saying ‘but make it small’) when the SuperBot can change the related data.

SuperBot: What can I do for you? (This is a generic welcome statement from SuperBot).

User: Hi

SuperBot: Hi there, how can I help? (The SuperBot recognizes that there is a user and tries to identify his intent to forward him to the relevant dialog bot).

User: I would like a pizza.

SuperBot: What toppings do you want on your pizza? (The bot recognizes ‘pizza’ as an entity and the intent ‘buy a pizza’ from user's utterance. The SuperBot identifies that there is a dialog hot which can handle this request and hands over the conversation to the dialog hot. The dialog bot knows what to do. The dialog bot is trying to get all data slots filled to process the user's request. Since not all slots, such as toppings, size and address, are filled yet, the bot is trying to get this information from the user).

User: What an the options? (The users do not know what toppings are available. So he is asking back. The bot can handle this ask and replies).

SuperBot; The options are salami, onion, bacon, mushroom, pepper: (User's intent is to get a list of available topping options. The bot replies accordingly).

User: I want salami and onions.

SuperBot: Of course! Which size do you prefer? (Next data slot needs to get filled: Size).

User: A large one, please

SuperBot: Great! Where do you want to the delivery? (Final missing data slot: Address).

User: At home, but make it small. (Here the user gives the address and the bot needs to get it from user's context since the user was just saying ‘home’ and the bot needs to replace the size which was large first with a small one. Thus, is only possible if the bot keeps the history and the user can change all acquired state during the dialog).

SuperBot: Great! All done!

User: Recap. (The user can ask the bot about its current status).

SuperBot: Already selected: a small pizza with onions and salami delivered to your home! (The bot replies with a friendly summary).

FIG. 3 may be also further explained using an example conversation that illustrates how to switch between topics handled by separate dialogs.

SuperBot: What can I do for you? (This is a generic welcome statement from SuperBot).

User: Hi, I would like a pizza.

SuperBot: What toppings do you want on your pizza? (The bot recognizes ‘pizza’ as an entity and the intent ‘buy a pizza’ from user's utterance. The SuperBot identifies that there is a dialog bot which can handle this request and hands over the conversation to the dialog bot. The dialog bot knows what to do. He is trying to get all data slots filled to process the user's request. Since not all slots, such as toppings, size arid address, are filled yet, the bot is trying to get this information from the user.

User: I want salami and bacon.

SuperBot: Of course! Which size do you prefer? (Next data slot needs to get filled: Size).

User: Let's hook a cab first (The user forces a context switch here. Before finishing the pizza order he wants to order a cab. This can happen in conversations).

SuperBot: Where do you start you journey? (The pizza hot does not understand ‘cab’ and sends this utterance back to the SuperBot. The SuperBot identifies the context switch and triggers the Uber bot that is now handling the ordering of the cab).

User: From home.

SuperBots: Great thanks! What cat type can we offer you? (Here, the cab bot wants to fill his data slots, such as car type, start address and destination address).

User: A regular one.

Cab ordering conversation is completed here.

SuperBot: OK! All done!

User: Let's finish the pizza order. (The user wants to get back to the pizza order).

SuperBot: Sure! What see would you like? (The can bot is done and hands over the conversation to the SuperBot. The SuperBot identifies the ‘pizza’ utterance and hands over again to the pizza bot. The pizza bot still is aware of the status of the conversation and can continue from there).

User: A large one, please.

SuperBot: Great! Where do you want to the delivery? (Final missing data slot: Address).

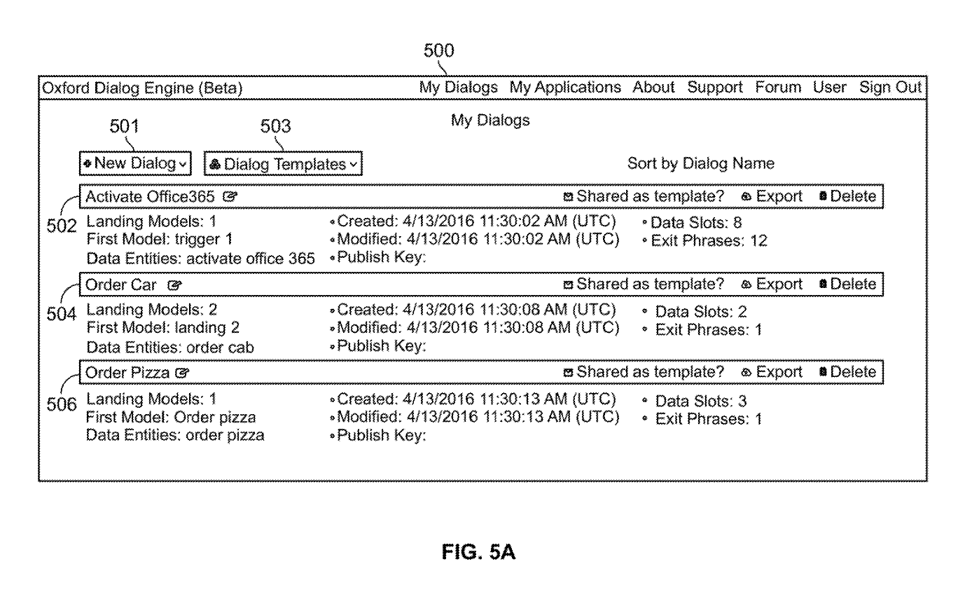

FIG. 4A is an example dialog structure for use in the SuperBot according to the embodiments. FIG. 4A illustrates how the use of flow engine 200 allows decoupling of the intelligence of a dialog from the authoring experience. To allow the decoupling, a particular structure is utilized by a dialog author to define a dialog. The structure includes properties to allow interaction with flow engine 200 in an efficient manner. However, structure/properties/data that may be handled and executed by flow engine 200 as part of flow engine 200's generic dialog handling capability is not required for the dialog structure of FIG. 4A. FIG. 4A shows dialog structure 400 that may be configured for a dialog including dialog model indicator 402 and properties 404. Properties 404 include a list of properties 404a to 404j for the dialog. The list of properties 404 may include other properties and may be added to and/or updated as flow engine 200 evolves over time. “AutoFill” 404a is a Boolean indicating whether the dialog may be completed by making use of the user context. “Common trigger” 404b defines an utterance that triggers the dialog. “Complete” 404c is a property that refers to (indicates) whether the dialog has been successfully delivered to the user. “Description” 404d is property including dialog metadata. “Exit phrase 404e” defines a final response delivered to the user when the dialog is completed. Exit phrase 404e may be either scripted, the result of a piece of code being executed or combination of both. “Landing models” 404f are the triggers to the dialog. Landing models 404f may be regular expressions, language models, keywords etc. “Name” 404g defines the identifier of the dialog. “Repeatable” 404h is a property that indicates whether the dialog may be repeated. An optional attribute of repeatable 404h may indicate how often the dialog may be repeated. “Slots” 404i are specific dialog features for mining data from the user. “User context” 404j may be any information that is known a priori and can be potentially used.

FIG. 4B is an example data slot structure for a dialog used in the SuperBot. A data slot is the feature of the dialog used to mine data from the user. For example, slots 404i of FIG. 4A may be configured according to FIG. 4B. FIG. 4B shows data slot structure 406 that may be configured for a dialog including data slot indicator 408 and properties 410. Properties 410 include a list of properties 410a to 410g. “Condition” 410a defines circumstances under which the data slot may be used to mine information from the user. “Evaluation method” 410b defines a process that evaluates a user utterance against a state that the data slot is expecting to mine. “Mining utterance” 410c is a set of questions provided to the user in order to mine a state. “Name” 410d is the name of the data slot. “Response to mining utterance” 410e is the response from the user to a question. “Stale evaluation satisfied” 410f indicates if the desired state was acquired. “User utterance evaluator” 410g is a set of language models for processing the response to mining utterance 410e object.

FIG. 4C is an example exit structure for a dialog used in the SuperBot. FIG. 4C shows exit structure 412 that may be configured for a dialog and which includes “answer” 414 and “properties” 416. Properties 416 include “exit-phrase-conditions 416a that define the circumstances under which a particular exist phrase should be provided. Properties 416 also included “fulfillment” 416b that defines the code that is implemented in order get the data required for an exit phrase, and scripted-exit-phrases 416c that allow the dialog author to provide out of the box scripted exit phrases.

FIG. 4D is an example trigger structure for a dialog used in the SuperBot. FIG. 4D shows trigger structure 420 that includes trigger evaluator 422 and properties 424. Properties 424 include “landing satisfied” 424a which indicates whether the trigger has fired, “name” 424b that indicates what tokens from the utterances caused the trigger to fire, and “replaced tokens” 424c which indicates what tokens were replaced from the utterance. Properties 424 also include “used tokens” 424d which indicates which tokens have been used. Trigger structure 420 also include “methods” 426 that includes “evaluate” 426a which indicates that “trigger evaluator” 422 should implement the evaluate method to evaluate a user utterance, “get-ranking-info” 426b which indicates that trigger evaluator 422 should report how closely the utterance matched the trigger, and “reset” 426c which indicates that trigger evaluator 422 should provide a button for resetting all states captured.

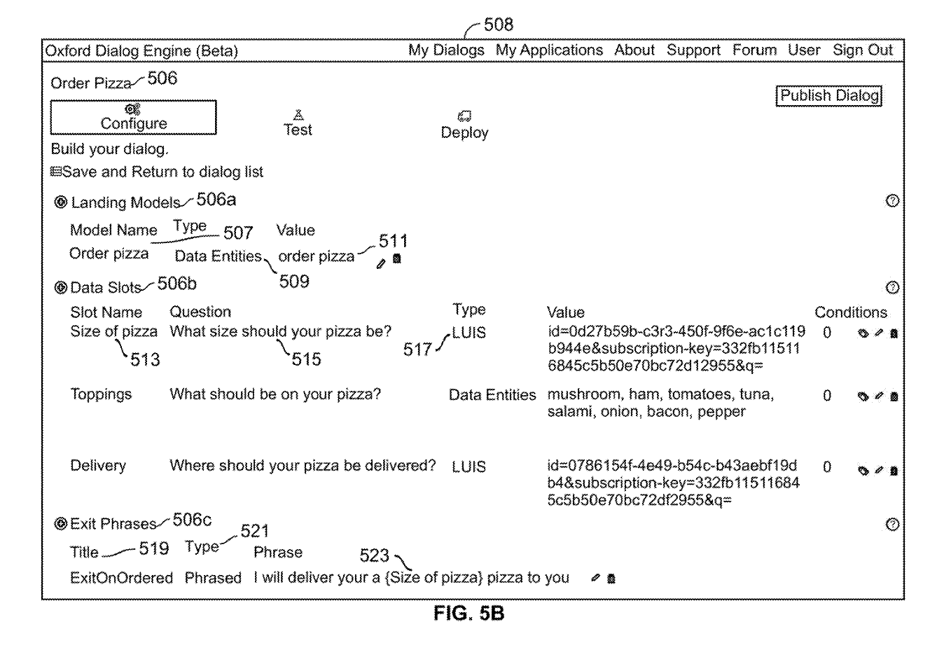

FIGS. 5A-5C are diagrams illustrating an example construction of a dialog for use in the SuperBot. FIG. 5A illustrates an example screen shot of a dialog author's workspace home page 500. The home page displays the author's existing dialogs 502, 504, and 506. The author may edit an existing dialog of dialogs 502, 504, and 506, create a new dialog from scratch by selecting button 501 or create a dialog from an existing template by selecting button 503. The existing templates may include templates of already prepared and/or shared dialogs. Example dialogs 502, 504 and 506 are shown as, respectively, dialogs “activate office 365” 502, “order car” 504, and “order pizza” 506.

FIG. 5B illustrates an example screen shot of an author's page 508 for editing and configuring dialog order pizza 506 of FIG. 5A. FIG. 5B shows how dialog order pizza 506 may be edited in terms of landing model 506a, data slots 506b and exit phrases 506c. For example, landing models 506a may include model named order pizza 507 that may be defined as type data entities 509 with value order pizza 511. Data slots 506b may include slot named size of pizza 513 that may associated with question 515 “What size should your pizza be?”, and defined as a language model and referenced from here for an language understanding intelligent service (LUIS) 517. Exit phrases 506c may include an exit phrase titled exit-on-ordered 519 of type phrased 521, associated with the phrase “I will deliver a (size of pizza) pizza to you.” The types for landing model, data slots and exit phrases may be regular expression (RegEx), data entities(which may be combined keywords), or language models.

FIG. 5C illustrates an example screen shot of an author's page 530 for deploying the dialog tided order pizza 506 as part of the SuperBot. In FIG. 5C the possible SuperBots are listed under the category titled “applications” 506d, and include the SuperBots “help” 508, “food” 510, “support” 512, and “office” 514. The author may select a SuperBot/application from SuperBots/applications 508-514 into which the dialog will be incorporated by clicking on the SuperBot/application box 508, 510, 512, or 514. As an alternative, by selecting “deploy applications” all SuperBots/applications get updated to include the dialog titled order pizza 506. A new SuperBot/application can be created by entering a name at 516.

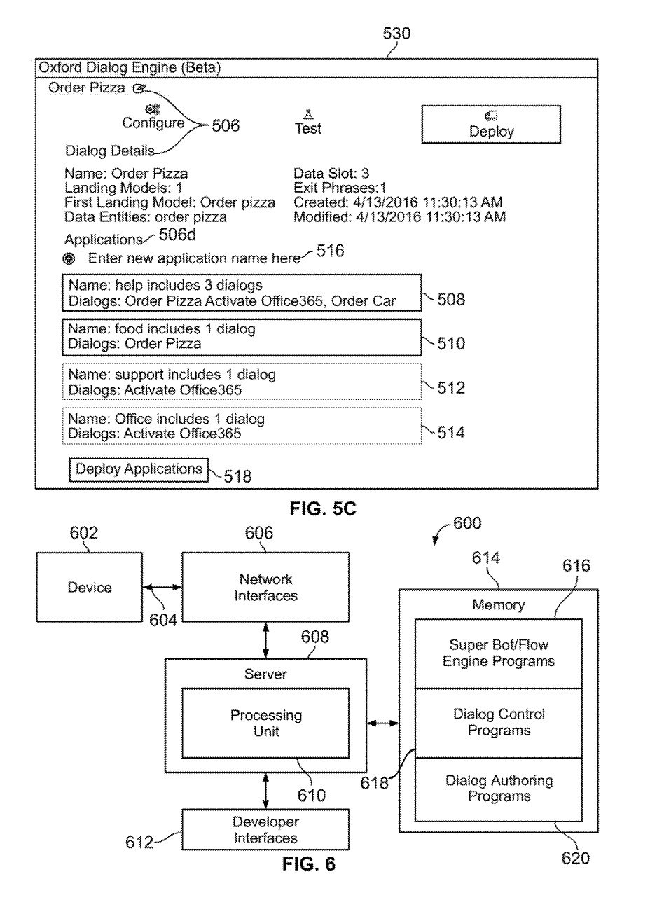

Referring now to FIG. 6, therein is a simplified block diagram of an example apparatus 600 that may be implemented to provide SuperBots according to the embodiments. The functions of apparatus 102 and flow engine 200 shown in FIGS. 1A and 1B may be implemented on an apparatus such as apparatus 600. Apparatus 600 may be implemented to communicate over a network, such as the internet, with devices to provide conversational input and output to users of the devices. For example, apparatus 600 may be implemented to communicate with device 602 of FIG. 6 that is implemented as device 110 or 112 of FIG. 1A.

Apparatus 600 may include a server 608 having processing unit 610, a memory 614, interfaces to other networks 606, and developer interfaces 612. The interfaces to other networks 606 allow communication between apparatus 600 and device 602 through, for example, the internet and a wireless system in which device 602 is operating. The interlaces to other networks 606 also allow apparatus 600 to communicate with other systems used in the implementations such as language processing programs. Developer interfaces 612 allow a developer/dialog author to configure/install one or more SuperBots on apparatus 600. The authoring of the dialogs may be clone remotely or at apparatus 600. Memory 614 may be implemented as any type of computer readable storage media, including non-volatile and volatile memory. Memory 614 is shown as including SuperBot/flow engine control programs 616, dialog control programs 618, and dialog authoring programs 620. Server 608 and processing unit 610 may comprise one or more processors, or other control circuitry, or any combination of processors and control circuitry that provide overall control of apparatus 600 according to the disclosed embodiments.

SuperBot/flow engine control programs 616 and dialog control programs 618 may be executed by processing unit 610 to control apparatus 600 to perform functions for providing SuperBot conversations illustrated and described in relation to FIG. 1, FIG. 2, and FIG. 3. Dialog authoring programs 620 may be executed by processing unit 610 to control apparatus 600 to perform functions that allow a user to author dialogs through the processes illustrated and described in relation to FIGS. 4A-4D and FIGS. 5A-5C. In alternative implementations, dialog authoring programs 620 may be implemented on another device and SuperBots and/or dialogs may be installed on apparatus 600 once authored.

Apparatus 600 is shown as including server 608 as a single server. However, server 608 may be representative of server functions or server systems provided by one or more servers or computing devices that may be co-located or geographically dispersed to implement apparatus 600. Portions of memory 614, SuperBot/flow engine control programs 616, dialog control programs 618, and dialog authoring programs 620 may also be co-located or geographically dispersed. The term server as used in this disclosure is used generally to include any computing devices or communications equipment that may be implemented to provide SuperBots according to the disclosed embodiments.

The example embodiments disclosed herein may be described in the general context of processor-executable code or instructions stored on memory that may comprise one or more computer readable storage media (e.g., tangible non-transitory computer-readable storage media such as memory 616). As should be readily understood, the terms “computer-readable storage media” or “non-transitory computer-readable media” include the media for storing of data, code and program instructions, such as memory 616, and do not include portions of the media for storing transitory propagated or modulated data communication signals.

The disclosed embodiments include an apparatus comprising an interface for receiving utterances and outputting responses, one or more processors in communication with the interface and memory in communication with the one or more processors, the memory comprising code that, when executed, causes the one or more processors to control the apparatus to activate a flow engine, the flow engine for coordinating at least a first and second dialog, receive a first utterance at the interface and invoke the first dialog in response to receiving the first utterance, determine contextual information for the conversation while using the first dialog, receive a second utterance at the interface and invoke the second dialog for the session in response to receiving the second utterance, utilize the contextual information to determine at least one response while using the second dialog, and, provide the at least one response at the interface. The contextual information may comprise first contextual information and the code further causes the one or more processors to control the apparatus to determine second contextual information for the conversation while using the second dialog, receive a third utterance at the interface and invoke the first dialog in response to receiving the third utterance, and, utilize the second contextual information to determine at least one response while using the first dialog. The apparatus may receive the second utterance while conducting the first dialog and invoke the second dialog by determining that the second utterance is not relevant to the first dialog, ranking the second utterance for relevance to the second dialog and at least one third dialog, determining the second utterance is most relevant to the second dialog as compared to the at least one third dialog, and, invoking the second dialog in response to the determination that the second utterance is most relevant to the second dialog. The at least one response may comprise a first at least one response and the code may further cause the one or more processors to control the apparatus to track state information for the conversation while using the first and second dialogs, and, utilize the state information to determine a second at least one response while using the second dialog.

The code may further causes the one or more processors to control the device to determine dialog activity, the dialog activity including an amount of activity of each of the first and second dialogs in the session as one or more third utterances are received, receive a fourth utterance at the interface, and, determine, based on the dialog activity, whether the first or second dialog is to be invoked in response to the fourth utterance. The code may further cause the one or more processors to control the apparatus to receive a third utterance at the interface while using the second dialog, determining that the third utterance is a request for information about the second dialog, determining metadata in a script of the second dialog, and, utilize the metadata to determine at least one response. The code may further cause the one or more processors to control the apparatus to receive a third utterance at the interface while using the second dialog, determine that the third utterance includes a negation, and, negotiate a response with the second dialog. The code may further cause the one or more processors to control the apparatus to receive a third utterance at the interface while using the second dialog, determine that the third utterance is an exit phrase for the first dialog, and, exit the first dialog in response to the third utterance.

The disclosed embodiments also include a method comprising activating a flow engine in an apparatus, the flow engine for coordinating at least a first and second dialog, receiving a first utterance at an interface of the apparatus and invoking a first dialog in response to receiving the first utterance, determining contextual information for the conversation while using the first dialog, receiving a second utterance at the interface while using the first dialog and invoking a second dialog in response to receiving the second utterance, utilizing the contextual information to determine at least one response while using the second dialog, and, providing the at least one response at the interface. The method may further comprising tracking state information for the conversation while using the first dialog, and, utilizing the state information to determine the at least one response while using the second dialog. The method may further comprise determining dialog activity, the dialog activity including an amount of activity using each of the first and second dialogs in the session as one or more third utterances are received, receiving a fourth utterance at the interface, and, determining, based on the dialog activity, whether the first or second dialog is to be invoked in response to the fourth utterance. The method may further comprises determining second contextual information while using the second dialog, receiving a third utterance at the interface while using the second dialog and invoking the first dialog in response to receiving the third utterance, and, utilizing the second contextual information to determine at least one response while using the first dialog. The method may further comprise receiving a third utterance at the interface while conducting the second dialog, determining the third utterance is a request for information about the second dialog, determining metadata in a script of the second dialog, and, utilize the metadata to determine at least one response. The method of may further comprising receiving a third utterance at the interface while using the second dialog, determining that the third utterance includes a negation, and, negotiating a response with the second dialog. The receiving the second utterance and invoking the second dialog may further comprise determining that the second utterance is not relevant to the first dialog, ranking the second utterance for relevance to the second dialog and at least one third dialog, determining the second utterance is most relevant to the second dialog as compared to the at least one third dialog, and, invoking the second dialog in response to the determination that the second utterance is most relevant to the second dialog.

The disclosed embodiments further include a flow engine including one or more processors and memory in communication with the one or more processors, the memory comprising code that, when executed, is operable to control the flow engine to receive a plurality of utterances during a conversation, manage the conversation by switching between a plurality of dialogs based on each of the received plurality of utterances, track context information while using each of the plurality of dialogs, and, utilize the context information tracked in a first dialog of the plurality of dialogs in at least a second dialog of the plurality of dialogs to generate at least one response. The code may be further operable to control the flow engine to track state information while using each of the plurality of dialogs, and, classify each of the plurality of dialogs as available, activated, or completed based on the tracked state information. Each of the plurality of utterances may include a trigger, the flow engine may receive a first trigger in a first utterance of the plurality of utterances, determine a third and fourth dialog of the plurality of dialogs as associated with the first trigger, generate a query as to which of the third or fourth dialog was referred to by the first utterance, and switch to the third dialog based on an a second utterance of the plurality of utterances, received in response to the query. The flow engine may utilize the context information tracked in the first dialog of the plurality of dialogs in the second dialog of the plurality of dialogs by filling a data slot in the second dialog with selected information in the tracked context information. The flow engine may further tracks state information while using the plurality of dialogs, and utilize the state information tracked in a first dialog of the plurality of dialogs in at least a second dialog of the plurality of dialogs. The flow engine may switch between the plurality of dialogs based on each of the received plurality of utterances by ranking each of the plurality of dialogs in relation to each other for a selected utterance of the received plurality of utterances, and switching to a dialog of the plurality of dialogs having the highest ranking for the selected utterance.

While implementations have been disclosed and described as having functions implemented on particular wireless devices operating in a network, one or more of the described functions for the devices may be implemented on a different one of the devices than shown in the figures, or on different types of equipment operating in different systems.

1. An apparatus comprising:
an interface for receiving conversational inputs and outputting conversational outputs;
one or more processors in communication with the interface and memory in communication with the one or more processors, the memory comprising a plurality of dialogs, each comprising one or more data slots, and code, that when executed, causes the one or more processors to control the apparatus to:
activate a flow engine, the flow engine for coordinating a plurality of dialogs;
receive a first conversational input including a first utterance at the interfaces;
perform language processing on the first utterance to determine a first structure;
a first ranking based on the first structure, the first ranking indicating the relevance each of a plurality of dialogs to the first structure;
invoke, based on the first ranking, a first dialog of the plurality of dialogs to provide first conversational outputs to the interface as queries to fill one or more data slots of the first dialog and receive second conversational input from the interface in response to the first conversational outputs;
perform language processing on one or more second utterances and a third utterance included in the second conversational input to determine one or more second structures and a third structure, respectively;
fill the one or more data slots of the first dialog and determine contextual in formation for the first dialog based on the one or more second structures, and determine, based on the third structure, that the third utterance is not recognized by the first dialog;
generate a second ranking, the second ranking indicating the relevance of the plurality of dialogs, other than the first dialog, to the third structure and invoke a second dialog of the plurality of dialogs based on the second ranking;
utilize the contextual information to provide second conversational outputs for the second dialog at the interface.

2. The apparatus of claim 1, wherein the contextual information comprises first contextual information and the code further causes the one or more processors to control the apparatus to:
provide second conversational outputs to the interface as queries to fill one or more data slots of the second dialog, receive third conversational input from the interface in response to the second conversational outputs and determine second contextual information for the second dialog;
perform language processing on a fourth utterance included in the third conversational inputs to determine a fourth structure;
generate a third ranking, the third ranking indicating the relevance of the plurality of dialogs, other than the second dialog, to the third structure and invoke the first dialog based on the third ranking; and,
utilize the second contextual information to provide third conversational outputs for the first dialog at the interface.

3. (canceled)

4. The apparatus of claim 1, wherein the code further causes the one or more processors to control the apparatus to:
track state information for the first dialog while the first is invoked; and,
utilize the state information to provide the second conversational outputs for the second dialog.

5. The apparatus of claim 1, wherein the code further causes the one or more processors to control the device to:
determine dialog activity, the dialog activity including an amount of activity of each of the plurality of dialogs;
receive third conversational input comprising a fourth utterance at the interface;
perform language processing on the fourth utterance to determine a fourth structure; and,
determine, based on the fourth structure and the dialog activity, which of the plurality of dialogs is to be invoked in response to the fourth utterance.

6. The apparatus of claim 1, wherein the code further causes the one or more processors to control the apparatus to:
receive a third conversational input comprising a fourth utterance at the interface while the second dialog is invoked;
perform language processing on the fourth utterance to determine a fourth structure;
determine that the fourth utterance is a request for information about the second dialog based on the fourth structure;
determine metadata in a script of the second dialog; and
utilize the metadata to provide the second conversational outputs for the second dialog at the interface.

7. The apparatus of claim 1, wherein the code further causes the one or more processors to control the apparatus to:
receive third conversational input comprising a fourth utterance at the interface while the second dialog is invoked;
perform language processing on the fourth utterance to determine a fourth structure;
determine that the fourth utterance includes a negation based on the fourth structure; and,
negotiate a response to the negation with the second dialog.

8. The apparatus of claim 1, wherein the code further causes the one or more processors to control the apparatus to:
receive a third conversational input comprising a fourth utterance at the interface while the second dialog is invoked;
perform language processing on the fourth utterance to determine a fourth structure;
determine that the fourth utterance is an exit phrase for the first dialog based on the fourth structure; and,
exit the first dialog in response to the fourth utterance.

9. A method comprising:
activating a flow engine in an apparatus, the flow engine for coordinating a plurality of dialogs;
receiving a first conversational input including a first utterance at an interface of the apparatus;
performing language processing on the first utterance to determine a first structure;
generating a first ranking based on the first structure, the first ranking indicating the relevance each of a plurality of dialogs to the first structure;
invoking, based on the first ranking, a first dialog of the plurality of dialogs to provide first conversational outputs to the interface as queries to fill one or more data slots of the first dialog and receiving second conversational input from the interface in response to the first conversational outputs;
performing language processing on one or more second utterances and a third utterance included in the second conversational input to determine one or more second structures and a third structure, respectively;
filling the one or more data slots of the first dialog and determining contextual information for the first dialog based on the one or more second structures;
determining, based on the third structure, that the third utterance is not recognized by the first dialog;
generating a second ranking, the second ranking indicating the relevance of the plurality of dialogs, other than the first dialog, to the third structure and invoking a second dialog of the plurality of dialogs based on the second ranking;
utilizing the contextual information to provide second conversational outputs for the second dialog at the interface.

10. The method of claim 9, further comprising:
tracking state information for the first dialog while the first dialog is invoked; and,
utilizing the state information to provide the second conversational outputs for the second dialog at the interface.

11. The method of claim 9, further comprising:
determining dialog activity, the dialog activity including an amount of activity of each of the plurality of dialogs;
receiving third conversational input comprising a fourth utterance at the interface;
performing language processing on the fourth utterance to determine a fourth structure; and,
determining, based on the fourth structure and the dialog activity, which off the plurality of dialogs is to be invoked in response to the fourth utterance.

12. The method of claim 9, further comprising:
providing second conversational outputs to the interface as queries to fill one or more data slots of the second dialog, receiving third conversational input from the interface in response to the second conversational outputs and determining second contextual information for the second dialog;
performing language processing on a fourth utterance included in the third conversational inputs to determine a fourth structure;
generating a third ranking, the third ranking indicating the relevance of the plurality of dialogs, other than the second dialog, to the third structure and invoking the first dialog based on the third ranking; and,
utilizing the second contextual information to determine at least one response while using the first dialog to provide third conversational outputs for the first dialog at the interface.

13. The method of claim 9, further comprising;
receiving a third conversational, input comprising a fourth utterance at the interface while the second dialog is invoked;
performing language processing on the fourth utterance to determine a fourth structure;
determining that the fourth utterance is a request for information about the second dialog based on the fourth structure;
determining metadata in a script of the second dialog; and
utilizing the metadata to provide the second conversational outputs for the second dialog at the interface.

14. The method of claim 9, further comprising:
receiving a third conversational input comprising a fourth utterance at the interface while the second dialog is invoked;
performing language processing on the fourth utterance to determine a fourth structure;
determining that the fourth utterance includes a negation based on the fourth structure; and,
negotiating a response to the negation with the second dialog.

15. The method of claim 9, further comprising:
receiving a third conversational input comprising a fourth utterance at the interface while the second dialog is invoked;
performing language processing on the fourth utterance to determine a fourth structure;
determining that the fourth utterance is an exit phase for the first dialog based on the fourth structure; and,
exit the first dialog in response to the fourth utterance.

16. A flow engine including an interface, one or more processors in communication with the interface, and memory in communication with the one or more processors, the memory comprising a plurality of dialogs each comprising one or more data slots, and code, that when executed, is operable to control the flow engine to:
receive conversational input comprising a plurality of utterances at the interface;
perform language processing on the plurality of utterance to determine a plurality of structures, each corresponding to one of the plurality of utterances;
generate a plurality of rankings of a plurality of dialogs, each ranking based on one of the plurality of structures and associated with a corresponding one of the plurality of utterances;
manage the plurality of dialogs by switching between each of the plurality of dialogs based on the plurality of rankings, as the conversational input is received;
track context information while using each of the plurality of dialogs; and,
utilize the context information tracked in a first dialog of the plurality of dialogs in at least one second dialog of the plurality of dialogs to provide conversational outputs at the interface as queries to fill one or more data slots of the at least one second dialog of the plurality of dialogs.

17. The flow engine of claim 16, wherein the code is further operable to control the flow engine to:
track state information while using each of the plurality of dialogs; and,
classify each of the plurality of dialogs as available, activated, and completed based on the tracked state information.

18. (canceled)

19. The flow engine of claim 16, wherein the flow engine utilizes the context information tracked in the first dialog of the plurality of dialogs in the at least one second dialog of the plurality of dialogs by filling a data slot of the at least one second dialog with information in the tracked context information.

20. The flow engine of claim 16, wherein the flow engine further tracks state information while using the plurality of dialogs, and utilizes the state information tracked in a first dialog of the plurality of dialogs in at least a second dialog of the plurality of dialogs.

21. (canceled)
